(19) United States
(12) Patent Application Publication
(10) Pub. No.: US 2013/0042529 A1
(43) Pub. Date: Feb. 21, 2013

(54) GOLFING TURF EXTREME WEATHER SURVIVAL APPARATUS AND METHODS

(71) Applicant: Bryan Roe, Palm Desert, CA (US)

(72) Inventor: Bryan Roe, Palm Desert, CA (US)

(21) Appl. No.: 13/588,850

(22) Filed: Aug. 17, 2012

Related U.S. Application Data
(60) Provisional application No. 61/525,668, filed on Aug. 19, 2011.

(51) Int. Cl. A01G 1/12; A01G 13/00

(52) U.S. Cl. 47/1.1 F; 47/58.1 R

(57) ABSTRACT

Described herein generally are apparatus, systems and methods for preserving an area of turf in extreme weather conditions. The systems generally include at least one fan located adjacent to an area of turf; a pressurized water source coupled to the at least one fan; and at least one nozzle associated with the pressurized water source; wherein the at least one nozzle is configured to allow at least a portion of water from the pressurized water source to pass through the at least one nozzle and contact an airflow from the at least one fan, and wherein the system is configured to provide cooling to the area of turf without wetting the area of turf.

### CROSS REFERENCE TO RELATED APPLICATIONS

This application claims the benefit of U.S. provisional patent application No. 61/525,668, filed Aug. 19, 2011, the entire disclosure of which is incorporated herein by reference in its entirety.

### FIELD

Described herein are apparatus, systems and methods that can prevent damage to or accelerate growth of turf during extreme weather conditions.

### BACKGROUND

Over the last century, golf has become a widely popular sport. Golf has also become more than just a sport; it has become a stress relief tool, a business tool, a social acceptance tool and the like. As a result of its wide popularity and plethora of social uses, courses have been constructed all over the world in virtually every conceivable climate.

Although golfers love having golf courses everywhere they go from the resorts in Salt Lake City, the jungles of South America, or the deserts of the Middle East, greens keepers put substantial amounts of time and energy into keeping golf course turf lush and green. Methods used to properly maintain a green, or even an entire golf course for that matter, in humid conditions is very much different than a very arid climate.

On top of climate conditions, different grass or turf types are generally used on different parts or portions of a golf course. For example, in a simple arrangement, a tee area can have one type of grass, the fairway another and the putting green another. In more elaborate types of courses, there can be countless numbers of different turf types present at different locations on the course (e.g. fringe, rough, common areas, cart paths, etc.).

With a complexity of climates and turf types, technologies are constantly evolving to maintain greener and lusher turf. However, despite current technologies, turf remains extremely difficult to maintain in extreme climates. For example, many turf types cannot handle heat loads, and the turf ends up browning and/or wilting despite receiving plentiful hydration. As such, apparatus, systems and methods need to be developed to allow proper maintenance of turf in heat extreme climates. The present description provides such apparatus, systems and methods.

### SUMMARY

Described herein are apparatus, systems and methods for preserving turf, for example golf greens, in extreme temperature and humidity conditions. Generally, the preservation systems comprise at least one fan located adjacent to an area of turf; a pressurized water source; and at least one nozzle associated with the pressurized water source and the at least one fan; wherein the preservation systems provide cooling to the turf without substantially wetting it.

Further described are systems for preserving an area of turf comprising at least one fan located adjacent to the area of turf; a pressurized water source coupled to the at least one fan; and at least one nozzle associated with the pressurized water source; wherein the at least one nozzle is configured to allow at least a portion of water from the pressurized water source to pass through the at least one nozzle and contact an airflow from the at least one fan, and wherein the system is configured to provide cooling to the area of turf without wetting it.

Also described herein are methods for preserving an area of turf comprising locating at least one fan adjacent to the area of turf; associating a pressurized water source including at least one nozzle with the at least one fan; and powering the fan and providing an airflow to contact a mist of water formed from water passing through the at least one nozzle directed at and over the area of turf thereby cooling the area of turf and not wetting it.

In one embodiment, the at least one fan can have a blade span of at least 24 inches. In another embodiment, the at least one fan can have a blade span of at least 50 inches. In some embodiments, the area of turf is a golf green, for example, a bentgrass golf green. In some embodiments, the area of turf are two adjacent greens.

In one embodiment, the pressurized water source is provided by at least one pump and can have a regulated and variable pressure. In some embodiments, two or more atomizing fog nozzles are associated with and/or coupled to at least one fan and programmed into at least two stages.

In one embodiment, a first stage can be activated when ambient temperature is at least about 85° F. This first stage can include water pressurized at about 600 psi. In another embodiment, a second stage can be activated when the ambient temperature is at least about 95° F. This second stage can include water pressurized at about 1,000 psi.

In some embodiments, the pressurized water source can provide a total flow through the system of at least about 1 gal/min. The at least one nozzle can create a droplet size of about 10 μm to about 100 μm.

Further described herein are methods for preserving a bentgrass golf green comprising locating a fan adjacent to the bentgrass golf green; wherein the fan is associated with a high pressure water source providing a total flow rate of at least 1 gal/min; and activating the fan and providing a mist from a least one atomizing fog nozzle associated with the high pressure water source such that a mist of water is directed at and over the bentgrass golf green thereby cooling the bentgrass golf green and not wetting the bentgrass golf green.

### BRIEF DESCRIPTION OF THE DRAWINGS

FIG. 1 illustrates a turf conditioning method termed “syringing.”

FIG. 2 illustrates grass blades covered in water droplets when using the syringing method.

FIG. 3 illustrates an exemplary system according to the present description.

FIGS. 4A and 4B illustrate nozzle configurations.

FIG. 5 illustrates grass blades when using the systems and methods described herein. The grass blades have substantially no water droplets on them.

FIG. 6 illustrates a multi-fan configuration for preserving golf greens.

FIG. 7 illustrates a golf course-wide system for preserving golf greens.

FIG. 8 is a graphical depiction of drops in canopy temperatures on a golf green using the systems and methods described herein.

### DETAILED DESCRIPTION

Described herein generally are apparatus, systems and methods for preserving an area of turf in extreme weather conditions. The extreme weather conditions can be, for example, hot and dry or hot and humid. The systems and methods can include at least one fan located adjacent to the area of turf. The systems and methods can also include a pressurized water source and at least one water nozzle associated with the pressurized water source and the at least one fan. The systems and methods described provide cooling of the air above the area of turf and/or conditioning of the area of turf without substantially wetting it.

Types of turf to preserve include all types of grass. In an example embodiment, the turf is grass used on golf courses, for example, teeing surfaces, fairways, roughs, greens, fringes, boundary turf and the like. Types of grass include, but are not limited to zoysiagrass sod, Bermuda grass, Kentucky Bluegrass, rye grass, zoysia, St. Augustine grass, bentgrass, and combinations thereof.

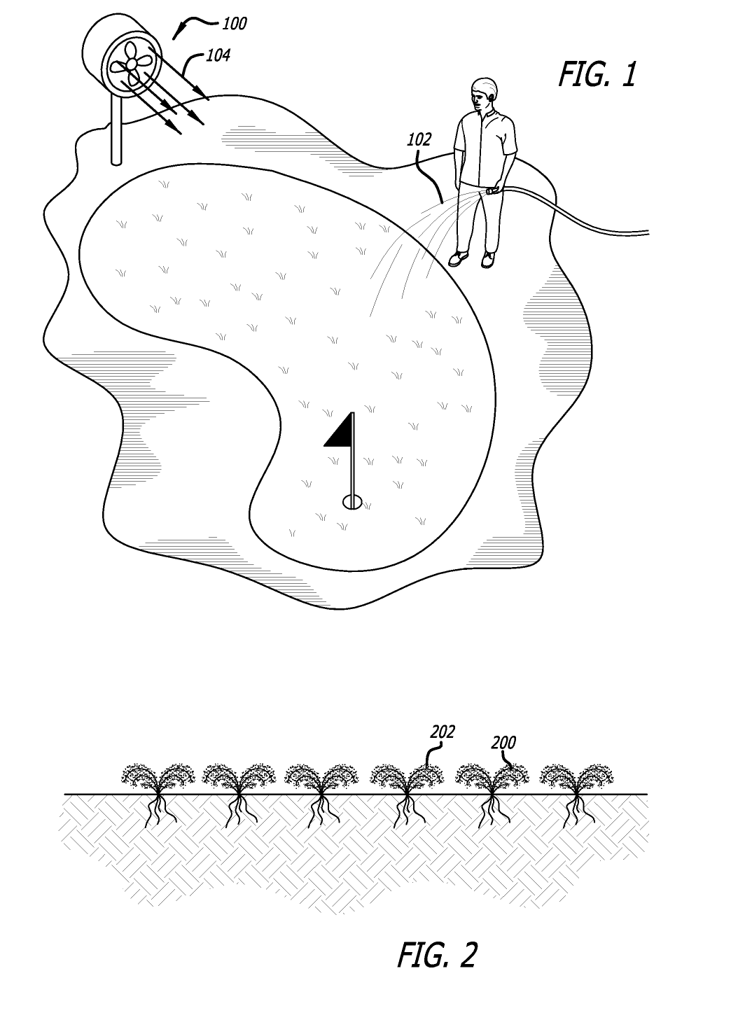

Conventional systems and methods illustrated in FIG. 1, utilize a combination of a fan(s) 100 and syringing 102. For an area of turf such as a golf green, a groundskeeper applies a light sprinkling of water onto the grass thereby wetting the blades of grass as illustrated in FIG. 2. Using syringing 102, individual blades of grass 200 are populated with water droplets 202. The theory under this type of treatment is that when air is blown 104 across the wet grass, changes in pressure over the grass force the water droplets to evaporate taking energy in the form, of heat with them.

However, this method is not without consequences. For example, in very hot and humid conditions, the amount of water in the ambient air prevents efficient evaporation of the water droplets 202 on the grass blades 200. In turn, the droplets heat up and often burn and/or shock the grass, leading to both unpleasant appearance and diminished rooting of the grass itself.

In order to eclipse the potential dangers of syringing 102, many greens keepers of the prior art have resorted to using fan 100 alone. However, without the evaporation power of droplets 202, fan 100 alone is generally not sufficient to maintain healthy, green and well rooted grass in extreme climate situations.

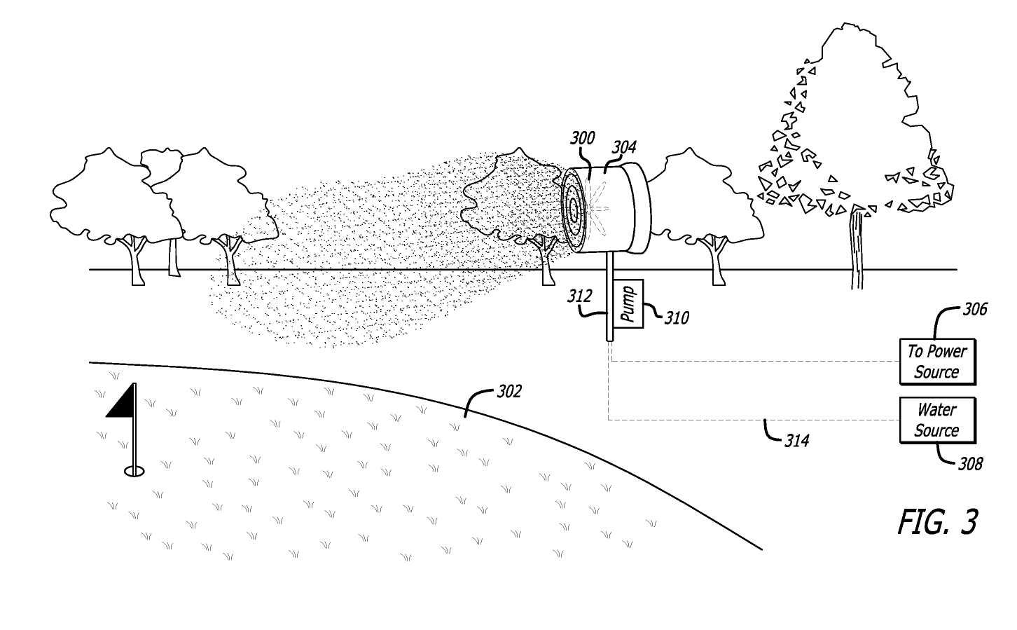

The presently described systems in contrast provide ambient temperature and humidity conditioning without substantially wetting the area of turf of interest. As illustrated in FIG. 3, at least one fan 300 is located adjacent to the area of turf 302 of interest. Many fan configurations are envisioned according to the present description. For example, fan 300 can have one blade, two blades, three blades, four blades, five blades, six blades, seven blades, eight blades, nine blades, ten blades, eleven blades, twelve blades or more blades. As will be discussed in further detail, the number of blades used may depend on the particular application.

The diameter of the blades, also referred to as blade span is defined as the unit of measure from the two outermost points along the theoretical blade circumference. The diameter may vary. Some blades may have a diameter of at least 22 inches, about 24 inches, about 30 inches, about 32 inches, about 36 inches, about 40 inches, about 42 inches, about 46 inches, about 50 inches, about 56 inches, about 60 inches, about 72 inches, or more. The number of blades used may depend on the particular application and the amount of airflow needed.

In some embodiments, a fan may spin at a constant speed. In other embodiments, the fan can spin at variable speeds. In either case, a fan can spin at a speed of about 25 RPM, about 50 RPM, about 75 RPM, about 100 RPM, about 200 RPM, about 300 RPM, about 400 RPM, about 500 RPM, about 600 RPM, about 700 RPM, about 800 RPM, about 900 RPM, about 1,000 RPM, about 1,100 RPM, about 1,200 RPM, about 1,300 RPM, about 1,400 RPM, about 1,500 RPM, about 1,600 RPM, about 1,700 RPM, about 1,800 RPM, about 1,900 RPM, about 2,000 RPM, about 2,100 RPM, about 2,200 RPM, about 2,300 RPM, about 2,400 RPM, about 2,500 RPM, about 2,600 RPM, about 2,700 RPM, about 2,800 RPM, about 2,900 RPM, about 3,000 RPM, about 3,100 RPM, about 3,200 RPM, about 3,300 RPM, about 3,400 RPM, about 3,500 RPM, or more. The actual speed of fan rotation can depend on many factors such as, but not limited to blade span, blade pitch, blade surface area, water pressure, relative humidity, ambient temperature and the like. For example, larger fans with fewer blades may give off the similar amounts of air as smaller fans with more blades or larger blade surfaces. Likewise, larger fans can spin at slower speeds than smaller equivalents to provide similar amounts of airflow output. One skilled in the art understands this and can choose and appropriate fan for a given output need.

In other embodiments, a fan can be a bladeless fan. Bladeless fans prevent buffeting which can cause choppiness in the airflow from the fan. Conversely, a bladeless fan not only supplies a constant stream of air, but because of the use of acceleration technologies, the amount of air in the resulting air stream from the fan is multiplied as compared that the air stream of an ordinary bladed fan.

A fan 300 can include shroud 304 to channel its air in a particular direction or range of directions. For example, as illustrated in FIG. 3, shroud 304 can assume a circular shape. In other embodiments, shroud 304 may have rectangular shapes to disperse air over a larger radial, or horizontal area than a circular shroud. In further embodiments, the shroud can shrink a fan's air channel thereby condensing and pressurizing the air before allowing the air to freely expand potentially lowering its temperature. In some embodiments, fan 300 does not include a shroud.

A fan can freely rotate left, right, up, down and a combination thereof. For example, a fan can change direction to account for wind direction or to offset areas of shade versus areas of direct sunlight. Even further, a fan can oscillate left and right to cover a larger area of turf.

In other embodiments, two fans can be placed back-to-back with sufficient distance between them to allow ingress of air. Such a configuration allows for airflow coverage in opposite directions. Further still, three or more fans can be arranged in a similar arrangement to provide triangular configurations, square configuration, pentagonal configurations and the like. The more fans included in such configurations, the more circumferential area that can be covered.

The system as a whole, and in particular the fan, includes a power source 306. A power source can be direct current or alternating current, and can be hardwired to the local power grid, can run off a generator, can run off a battery or batteries, can be powered by a solar panel or the like, or a combination thereof. In some embodiments, fan 300 is the only component of the system that requires power at the fan location.

A water source 308 is also included. Water can be fed into systems described herein directly from a municipal water source either of fresh or reclaimed water. In some embodiments, water source 308 is fresh water because airborne reclaimed water can potentially be problematic when golfers are located adjacent to a system.

Water source 308 can further include a filter (not illustrated). Filtration methods can include mesh-like filters, carbon filters, UV light filtration, and the like. In some embodiments, the water can be filtered to remove sediment that can endanger a pumping system or clog a nozzle(s). In other embodiments, the filter can be used to clean the water to use around humans.

Water source 308 can also include a system (not illustrated) to introduce additives to the water. For example, fertilizers that can fall onto the turf once evaporation has occurred. Fragrances can also be added to the water to enhance the golfing or other experience. For example, a fresh forest scent can be added to the water on a golf course that is located near a forest. Further, in other embodiments, energy changing additives can be added to the water that can enhance water evaporation. On the other hand, in some embodiments, an additive can be added to the water that diminishes evaporation thereby allowing more heat energy to be absorbed by the water during evaporation. Such energy changing additives can be salts or liquids. In some embodiments, the additive does not harm the turf.

As a result of variability of municipal water pressures, in some embodiments, at least one pump 310 can be included as a component of the systems described herein. The at least one pump 310 can reside on the fan housing 312 itself, adjacent to the fan, in a vault or equipment area adjacent to the green to provide a regulated and potentially variable pressure to the system. In more elaborate systems, a central pump can be used that provides a regulated and potentially variable pressure water line 314 to each local fan system. Regulated and potentially variable pressure water can be directed through one or more water line to at least one nozzle associated with fan 300. In one embodiment, the water lines used are plastic and in other embodiments, the water lines are stainless steel. In an exemplary embodiment, the water lines are stainless steel.

Water lines 314 include at least one nozzle. A nozzle itself can be configured as atomizing, fogging, anti-wetting or a combination thereof. In some embodiments, a nozzle can be sized so that not wetting of the turf will occur without atomizing or fogging the emitted water. In any combination, a nozzle has an appropriately sized orifice. A combination of orifice size, water pressure and/or total flow rate allow water egress from nozzle(s) without wetting the area of turf of interest. Further, the nozzle can be selected such that the particle size emitted is sized appropriate for evaporation before wetting the turf.

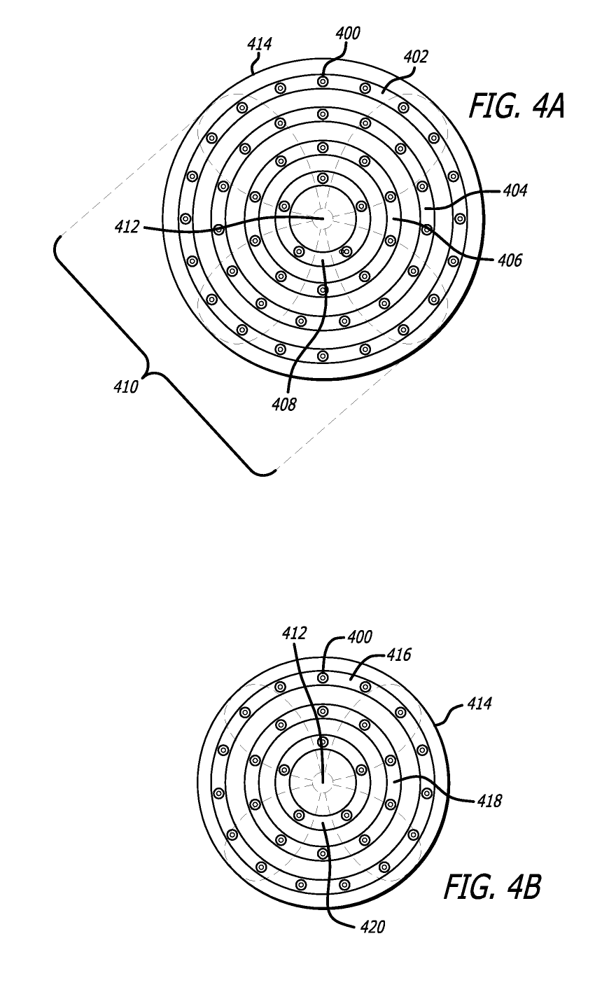

Referring to FIGS. 4A and 4B, two examples of nozzle configurations are illustrated. It is understood that more or fewer nozzles than those depicted can be used. In FIG. 4A, 50 nozzles 400 are used. In this embodiment, each ring is used as a different stage. For example the outermost ring is first stage 402. Each subsequent ring is a subsequent stage, second stage 404, third stage 406, and fourth stage 408. Herein, first stage 402 has 20 nozzles, second stage 404 has 15 nozzles, third stage 406 has 10 nozzles and fourth stage 408 has five nozzles. In some embodiments, all rings and all nozzles are part of a single stage.

In other embodiments, more than for stages can be used. Stages can be turned on or off in different combinations, further enhancing the number of possible stages. Flow rates to each stage can again further allow fine tuning of the cooling effect of the system.

In FIG. 4B, 30 nozzles 400 are used. In this embodiment, each ring is used as a different stage. For example, the outermost ring is alternate first stage 416. Each subsequent ring is a subsequent stage, alternate second stage 418, and alternate third stage 420. Alternate first stage 416 has 15 nozzles, alternate second stage 418 has 10 nozzles, and alternate third stage 420 has 5 nozzles. In some embodiments, all rings and all nozzles are part of a single stage. Differing numbers of nozzles and numbers of stages are envisioned herein.

In some embodiments, the number of nozzles, the type of nozzle used, the number of stages and the like can all be dependent on the total flow rate for the system. In one embodiment, the total flow rate is at least 0.5 gal/min. In other embodiments, the total flow rate can be about 0.5 gal/min, about 0.6 gal/min, about 0.7 gal/min, about 0.8 gal/min, about 0.9 gal/min, about 1.0 gal/min, about 1.1 gal/min, about 1.2 gal/min, about 1.3 gal/min, about 1.4 gal/min, about 1.5 gal/min, about 1.6 gal/min, about 1.7 gal/min, about 1.8 gal/min, about 1.9 gal/min, about 2.0 gal/min, about 2.1 gal/min about 2.2 gal/min, about 2.3 gal/min, about 2.4 gal/min, or about 2.5 gal/min. Flow rate can also be split into a flow per nozzle. For example, with a flow rate of 1 gal/min, if there were 10 nozzles, each nozzle can provide about 0.1 gal/min of fog and/or mist.

In some embodiments, the total flow rate may be dependent on the ambient heat index. Heat index is an index that combines air temperature and relative humidity and relates that combination to the human-perceived equivalent temperature. In such embodiments, generally, the higher the heat index, the higher the flow required to cool the area of turf.

In some embodiments, each stage can be programmed independently from another. For example, listed in Table 1 are example simple on/off stages for the fan illustrated in FIG. 4A.

TABLE 1

| | Outside Temperature/Relative Humidity | | | | | | | | | | | |
|---|---|---|---|---|---|---|---|---|---|---|---|---|
| | 80-90° F. | | | 90-100° F. | | | 100-110° F. | | | 110+° F. | | |
| | <33% | 34-66% | >67% | <33% | 34-66% | >67% | <33% | 34-66% | >67% | <33% | 34-66% | >67% |
| 1 | + | + | + | + | + | + | + | − | − | + | + | + |
| 2 | + | − | − | + | − | − | + | − | + | + | + | + |
| 3 | − | − | − | + | + | + | + | + | − | + | + | − |
| 4 | + | + | + | + | − | + | + | + | + | + | − | − |

+ is stage on, − is stage off.

In other embodiments, more complex systems can be developed. For example, instead of turning a particular stage on or off, the pressure delivered to a stage may vary depending on the environmental conditions. In such an embodiment, a pump can provide variable pressures to one or more different stages at a time. Table 2 enumerates example stage pressures that can be used.

TABLE 2

| | Stage Pressures (psi), Outside Temperature/Relative Humidity | | | | | | | | | | | |
|---|---|---|---|---|---|---|---|---|---|---|---|---|
| | 80-90° F. | | | 90-100° F. | | | 100-110° F. | | | 110+° F. | | |
| | <33% | 34-66% | >67% | <33% | 34-66% | >67% | <33% | 34-66% | >67% | <33% | 34-66% | >67% |
| 1 | 600 | 600 | 500 | 900 | 800 | 700 | 1100 | 0 | 1000 | 1500 | 1500 | 1500 |
| 2 | 600 | 0 | 500 | 900 | 0 | 700 | 1100 | 1100 | 1000 | 1500 | 1500 | 1500 |
| 3 | 0 | 0 | 0 | 900 | 800 | 0 | 1100 | 0 | 0 | 1500 | 1500 | 1500 |
| 4 | 600 | 600 | 500 | 900 | 800 | 700 | 1100 | 1100 | 1000 | 1500 | 1500 | 1500 |

In still other embodiments, particular stages can be turned on or off depending on the ambient heat index.

As discussed above, FIG. 4A illustrates blade span 410. In this embodiment, each stage is located within blade span 410 while no nozzles or stages are located over fan hub 412. Also, all nozzles and stages are located within shroud 414. In some embodiments, nozzles need not be located within shroud 414.

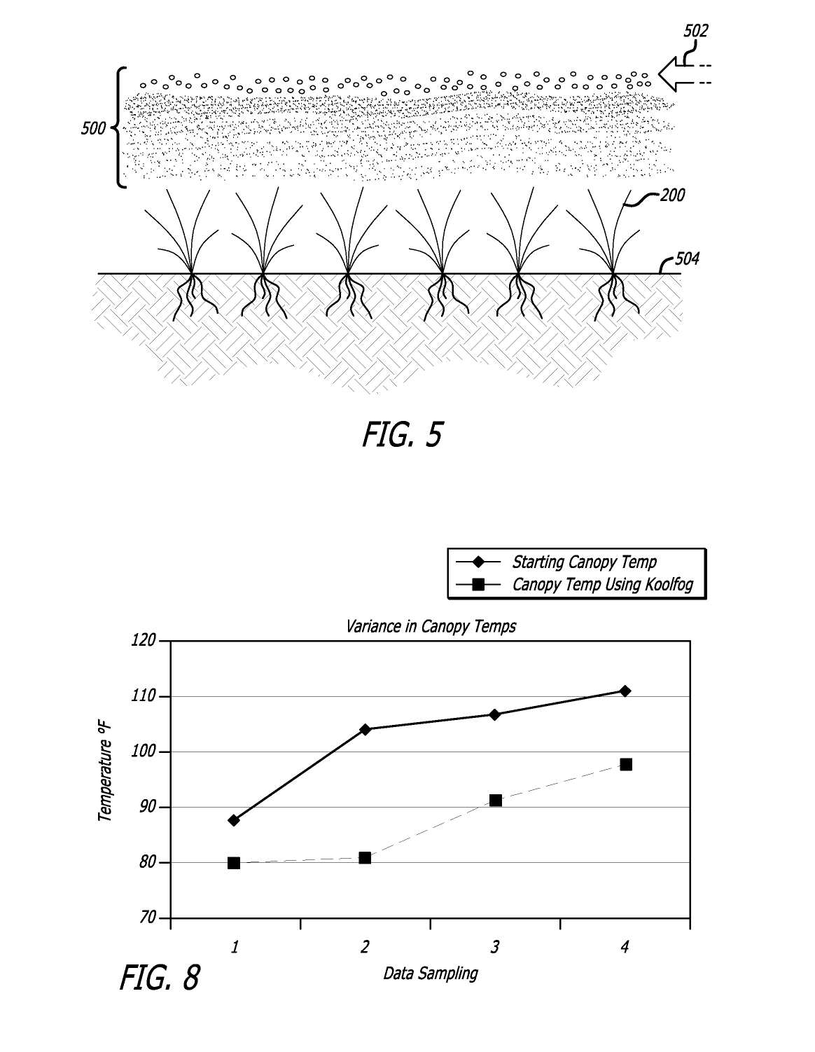

As illustrated in FIG. 5, a stream of fog 500 is directed across 502 area of turf 504. However, unlike FIG. 2, blades of grass 200 are not covered in water droplets 202. In fact, area of turf 504 is not wet at all or not substantially wet. In some embodiments, not substantially wet can be used to mean that not more than about 20%, about 10%, about 5% about 1% of a blade's surface area has accumulated moisture. The systems described herein do not have water applied directly and intentionally on the turf, grass, or blades of grass to provide a cooling and/or conditioning effect.

The systems described herein can produce droplet sizes which do not substantially wet the turf. Different droplet sizes can be achieved by varying the total flow rate and the nozzle configuration. The systems described herein can create droplet sizes down to about 1 μm. In some embodiments, the systems can create droplet sizes of about 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 110 μm or 120 μm. Different ranges of the above droplet sizes can also be created. For example, a droplet size distribution of about 10 μm to about 100 μm can be achieved.

Also, it can be noted in FIG. 5, that by cooling the area of turf as described herein, roots tend to more fully develop of grow deeper into the soil. Also, grass is more lush and green despite the potential for turf shock (not illustrated).

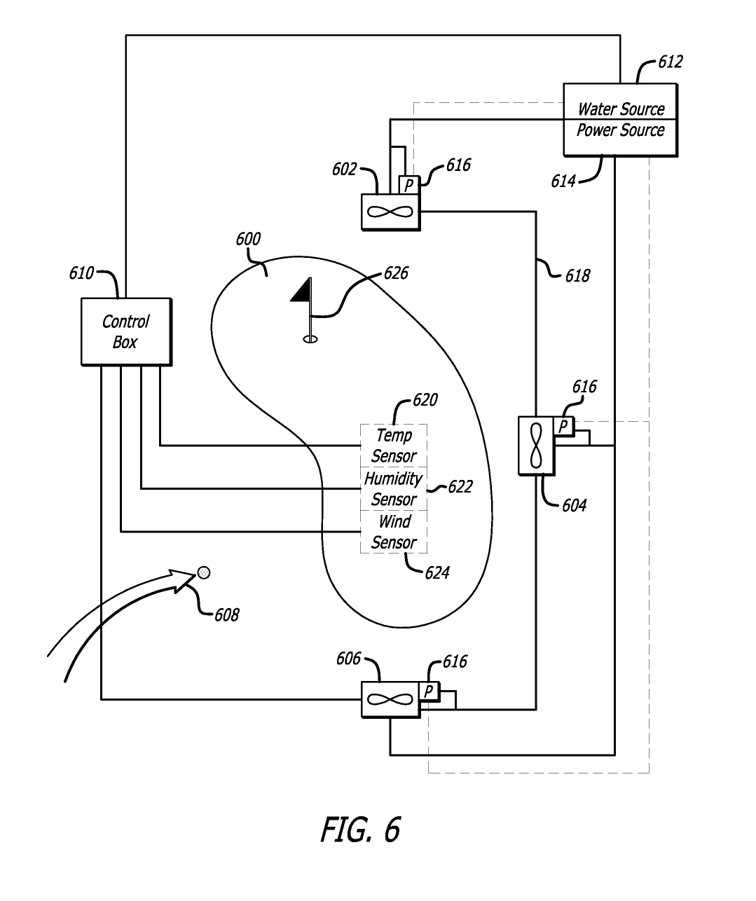

Also described are more elaborate systems for cooling a single golf green or an entire golf course. As illustrated in FIG. 6, golf green 600 is actively cooled by first fan 602, second fan 604, and third fan 606. The three fans are located in positions that do not interfere with approach shots 608. As golf is a highly technical game with many obstacles, the addition of systems as described herein can be hidden from the range of a golf shot. For example, systems can be placed at a position in the rear of the green or on a side of the green to prevent creating an obstacle for a golfer making an approach shot onto the green.

Depending on the size and shape of a green, more or less than three fans can be used to cool. In this embodiment, control box 610 controls some, many or all aspects of the system for golf green 600. For example, control box 610 can control first fan 602, second fan 604, and third fan 606, water source 612 and variable power source 614. Each of first fan 602, second fan 604, and third fan 606 has a pump 616 which is powered by variable power source 614 though power line 618.

Control box 610 can also control a litany of measuring devices. For example, control box 610 can control a temperature sensor 620, a humidity sensor 622 and/or a wind sensor 624 associated with golf green 600. Since each of first fan 602, second fan 604, and third fan 606 each can rotate independently, depending on wind speed and direction, each of first fan 602, second fan 604, and third fan 606 can rotate to an optimal position for the most effective cooling.

In certain embodiments, temperature sensor 620, humidity sensor 622 and/or wind sensor 624 can be embodied within flag 626. For example, wind sensor 624 can be located at the top of flag 626 and temperature sensor 620 and humidity sensor 622 can be located near the bottom and flag 626 adjacent to the surface of golf green 600.

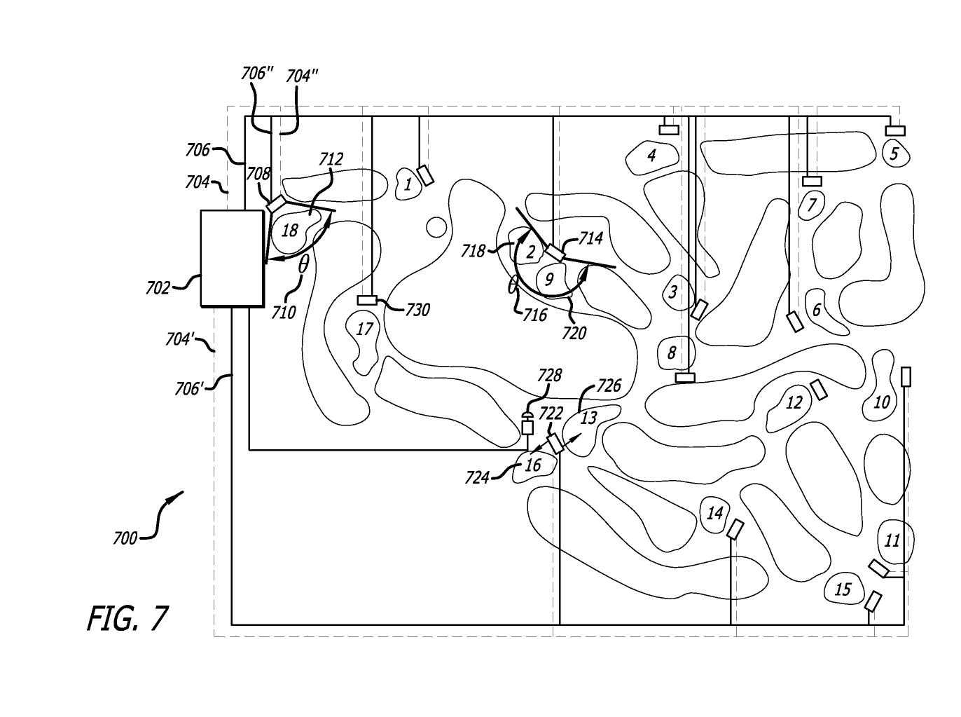

In some embodiments, the apparatus, systems and methods can be used to preserve areas of turf in extreme weather conditions for an entire golf course. FIG. 7 illustrates an example embodiment of system 700 for an entire 18 hole golf course. System 700 includes a central controller 702 wherein many of the systems functions are controlled. For example, water lines 704, 704′ originate at central controller 702. Also, power/communication lines 706, 706′ originate a central controller 702. Central controller 702 can include pumps, controllers, computer systems, power conditioners, and the like. Water lines 704, 704′ and power/communication lines 706, 706′ each are fed via branching lines 704″ and 706″ respectively to fan 708. Each fan 708 can be fed off main water or power lines or each fan can be fed off independent water and/or power line directly from central controller 702 or a subcontroller(s) (not illustrated).

Further, as described herein, fan 708 can oscillate through angle 710 to cover the entirety of green 712, for example. In another example, fan 714 can oscillate through second angle 716 to cover two adjacent greens 718 and 720. In still another example, fan 722 can have two physical fans inside pointing in opposite directions to cover two greens 724, 726.

System 700 may further includes an ability to control an independent pump or pumps at each fan. Water lines 704, 704′ can provide a pressurized water source, but independent pumps allow control over different delivery needs at a particular fan location. In other embodiments, water lines 704, 704′ provide pressure sufficient for all the fans.

Even further still, in some embodiments, system 700 can include remote 728 located adjacent to a tee box. Remote 728 can control, for example, the on and off functions of fan 730. There, a golfer can use remote 728 to turn off the system at a respective green to play out the hole at which time the system can be re-engaged.

### Example 1

### Non-Wetting System Installed in Indian Wells, Calif.

As discussed above, when a green's subsoil temperature reaches high levels, grass roots begin to shrink, diminishing the quality of a putting surface. At most courses basic methods to keep greens cool during the summer is to apply a light water coating over the greens (known as “syringing”) in addition to providing good airflow with the use of fans. However, there is little room for error as too heavy a dose of syringing may result in wet wilt or water scalding as the water on the green's surface forms a barrier and actually traps the heat rather than dissipating.

It was also discovered that well-placed fans can only nominally lower the surface temperature of a green whereas using a system according to the present description lowers surface temperatures without having to syringe the green's surface. Up to about 15° F. decrease in surface temperatures was demonstrated without substantially wetting the green's surface.

A non-wetting misting system was integrated with a TurfBreeze fan on Green #2, Mountain Course at the Vintage Club Golf Course. The pump was operated at 1,000 psi and was varied between about 1 gal/min and 4 gal/min. The tests were conducted during a heat wave in mid-summer. Temperature and humidity samples were acquired at a location on the green about 30 feet from the fan. During the testing period, halting of acute heat stress health on the green was observed. Also, regeneration of grass tissue was observed in the A4 Cool Season bentgrass that made up the greens.

Generally, the system provided better cooling as compared to fans alone by as much as 15° F. in our testing and higher reductions can be envisioned with more aggressive configurations; halted acute heat stress during the testing period as opposed to other greens where the system was not deployed; not only halted acute heat stress but resulted in regeneration of grass tissue during a period of time where it would have been nearly impossible to accomplish this; and represents a continuous-duty solution for heat stress throughout the summer months as opposed to alternative methods that cannot compete in terms of sustainability, resource requirements and effectiveness.

Reductions in temperatures are illustrated in FIG. 8. In all cases, the system dropped canopy temperatures. Data was sampled over several days testing the effectiveness of the system in different climate conditions.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A system for preserving an area of turf comprising:
at least one fan located adjacent to the area of turf;
a pressurized water source coupled to the at least one fan; and
at least one nozzle associated with the pressurized water source;
wherein the at least one nozzle is configured to allow at least a portion of water from the pressurized water source to pass through the at least one nozzle and contact an airflow from the at least one fan, and wherein the system is configured to provide cooling to the area of turf without wetting the area of turf.

2. The system according to claim 1 wherein the at least one fan has a blade span of at least 24 inches.

3. The system according to claim 1 wherein the at least one fan has a blade span of at least 50 inches.

4. The system according to claim 1 wherein the area of turf is at least one golf green.

5. The system according to claim 4 wherein the golf green comprises bentgrass.

6. The system according to claim 1 wherein the pressurized water source is provided by at least one pump.

7. The system according to claim 1 wherein the pressurized water source provides a total flow through the system of at least about 1 gal/min.

8. The system according to claim 1 wherein two or more nozzles are associated with at least two stages.

9. The system according to claim 8 wherein the at least one nozzle creates a droplet size of about 10 μm to about 100 μm.

10. A method for preserving an area of turf comprising:
locating at least one fan adjacent to the area of turf;
associating a pressurized water source including at least one nozzle with the at least one fan; and
powering the fan and providing an airflow to contact a mist of water formed from water passing through the at least one nozzle directed at and over the area of turf thereby cooling the area of turf and not wetting the area of turf.

11. The method according to claim 10 wherein the at least one fan has a blade span of at least 24 inches.

12. The method according to claim 10 wherein the area of turf is a bentgrass golf green.

13. The method according to claim 10 wherein pressure is supplied to the pressurized water source by at least one pump.

14. The method according to claim 10 wherein the mist of water comprises droplets with a size of about 10 μm to about 100 μm.

15. The method according to claim 10 wherein the pressurized water source provides a total flow through the system of at least about 1 gal/min.

16. The method according to claim 10 wherein a first stage is activated when the ambient temperature is at least 85° F.

17. The method according to claim 10 wherein the first stage includes water pressurized at about 600 psi.

18. The method according to claim 10 wherein a second stage is activated when the ambient temperature is at least 95° F.

19. The method according to claim 18 wherein the first stage includes water pressurized at about 1,000 psi.

20. A method for preserving a bentgrass golf green comprising:
locating a fan adjacent to the bentgrass golf green; wherein the fan is associated with a high pressure water source providing a total flow rate of at least 1 gal/min; and
activating the fan and providing a mist from a least one atomizing fog nozzle associated with the high pressure water source such that a mist of water is directed at and over the bentgrass golf green thereby cooling the bentgrass golf green and not wetting the bentgrass golf green.
